(19) United States
(12) Patent Application Publication
(10) Pub. No.: US 2012/0265791 A1
(43) Pub. Date: Oct. 18, 2012

(54) FILE MANAGING METHOD AND MECHANISM

(75) Inventors: Gary KUNG, Santa Ana, CA (US); Musa Ibrahim KAKISH, Santa Ana, CA (US)

(73) Assignee: I/O INTERCONNECT, LTD., Santa Ana, CA (US)

(21) Appl. No.: 13/088,696

(22) Filed: Apr. 18, 2011

(51) Int. Cl. G06F 17/30

(52) U.S. Cl. 707/822; 707/E17.01

(57) ABSTRACT

A file managing method and a file managing mechanism for processing files from a first electronic device on a second electronic device are provided. The file managing method comprises steps of: detecting whether the first electronic device is connected to the second electronic device; uploading a file to be processed from the first electronic device to the second electronic device while the first electronic device being connected to the second electronic device and being operated by inputting a command for processing the file on the first electronic device; sending the command to the second electronic device; and performing the command on the uploaded file by the second electronic device.

### BACKGROUND

1. Technical Field

The present invention generally relates to file managing technologies and, particularly to a file managing method and a file managing mechanism for processing files from a first electronic device on a second electronic device.

2. Description of the Related Art

Nowadays, the portable electronic device such as a smart phone becomes more and more popular. Take a smart phone as an example, a smart phone not only has function of a telephone, but also has another functions such as for receiving/sending E-mails, accessing and editing files, browsing webs, and so on.

However, a display panel and a keyboard of the smart phone are so small that it is not friendly for a user to implement above functions by the smart phone. Besides, implementing functions such as receiving/sending E-mails, accessing and editing files, browsing webs in the smart phone cannot be convenient as implementing the functions by a personal computer.

### BRIEF SUMMARY

The present invention is directed to provide a file managing method for processing a first electronic device on a second electronic device.

The present invention is also directed to provide a file managing mechanism for processing a first electronic device on a second electronic device.

In one aspect, a file managing method for processing files from a first electronic device on a second electronic device is provided. The file managing method comprises steps of: detecting whether the first electronic device is connected to the second electronic device; uploading a file to be processed from the first electronic device to the second electronic device while the first electronic device being connected to the second electronic device and being operated by inputting a command for processing the file on the first electronic device; sending the command to the second electronic device; and performing the command on the uploaded file by the second electronic device.

In an embodiment, the step of uploading a file to be processed from the first electronic device to the second electronic device comprises: downloading an index and locating the file to be processed in the second electronic device according to the index.

In an embodiment, the step of performing the command on the uploaded file by the second electronic device comprises: opening the file through a program in the second electronic device corresponding to a file type or extension of the file; creating a sync folder into the second electronic device wherein the file will be copied; editing the file in the second electronic device, and updating and indexing the sync folder on continuous bases; and storing the edited file into the storage of first electronic device.

In an embodiment, the file includes email attachments. The step of editing the file in the second electronic device, and updating and indexing the sync folder on continuous bases comprises steps of: prompting user to save changes; and saving an image copy of the file has an image copy to both storage of the second electronic device and storage of the first electronic device.

In an embodiment, the step of editing the file in the second electronic device, and updating and indexing the sync folder on continuous bases comprises step of: automatically saving an image copy of the file to both storage of the second electronic device and storage of the first electronic device.

In another aspect, a file management mechanism for processing files from a first electronic device on a second electronic device is provided. The file management mechanism comprises: a detector disposed in the first electronic device for detecting that if the first electronic device is connected to the second electronic device; a first transmitter disposed in the first electronic device for uploading a file to be processed from the first electronic device to the second electronic device while the first electronic device being connected to the second electronic device, and for sending a command inputted on the first electronic device for processing the file on the first electronic device to the second electronic device such that the command is performed on the uploaded file by the second electronic device.

In an embodiment, the file management mechanism further comprises: a second transmitter disposed in the second electronic device for downloading an index and locating the file to be processed in the second electronic device according to the index; a program corresponding to the file type or extension disposed in the second electronic device for opening and editing a file; and a processor disposed in the second electronic device for performing a program corresponding to the file type or extension to open or edit the file, creating a sync folder into the second electronic device wherein the file will be copied, when editing the file in the second electronic device, the processor updating and indexing the sync folder on continuous bases, and storing the edited file into the storage of first electronic device.

In an embodiment, the file includes email attachments. The processor is further provided for prompting user to save changes.

In an embodiment, the processor is further provided for automatically saving an image copy of the file to both storage of the second electronic device and storage of the first electronic device.

The present invention is implemented for file access from the first electronic device to the second electronic device with more user friendly peripherals while keeping the file reference location at the first electronic device. And upon connecting the first electronic device to the second electronic device, service running on both sides will manage the file opening and management is a way which will take advantage of the more user friendly environment of processing files using the second electronic device.

For above and another objectives, features, and advantages of the present invention being better understood and legibly, accompanying embodiments together with the drawings are particularized.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block view of the file managing mechanism in accordance with an embodiment of the present invention;

FIG. 2 is a block view of the file managing mechanism shown in FIG. 1 in used state; and

FIG. 3 is a flow chart of the file managing method in accordance with an embodiment of the present invention.

FIG. 4 is a flow chart of the step S304 in accordance with an embodiment of the present invention.

FIG. 5 is a flow chart of the step S405 in accordance with an embodiment of the present invention.

### DETAILED DESCRIPTION

With reference of the drawings, a file managing method and a file managing mechanism for processing files from a first electronic device on a second electronic device in accordance with an exemplary embodiment of present invention is described as follows.

The file managing mechanism of the present invention is implemented for file managing from a first electronic device (such as a smart phone) to a second electronic device (such as a personal computer) with more user friendly peripherals while keeping the file reference location at the first electronic device.

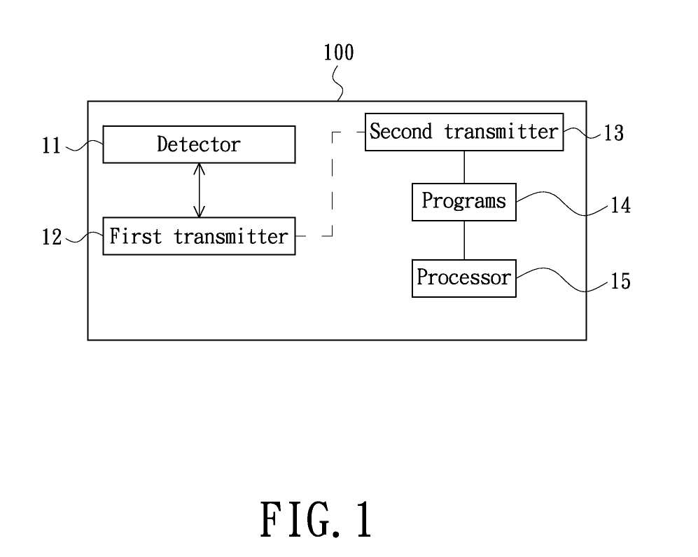

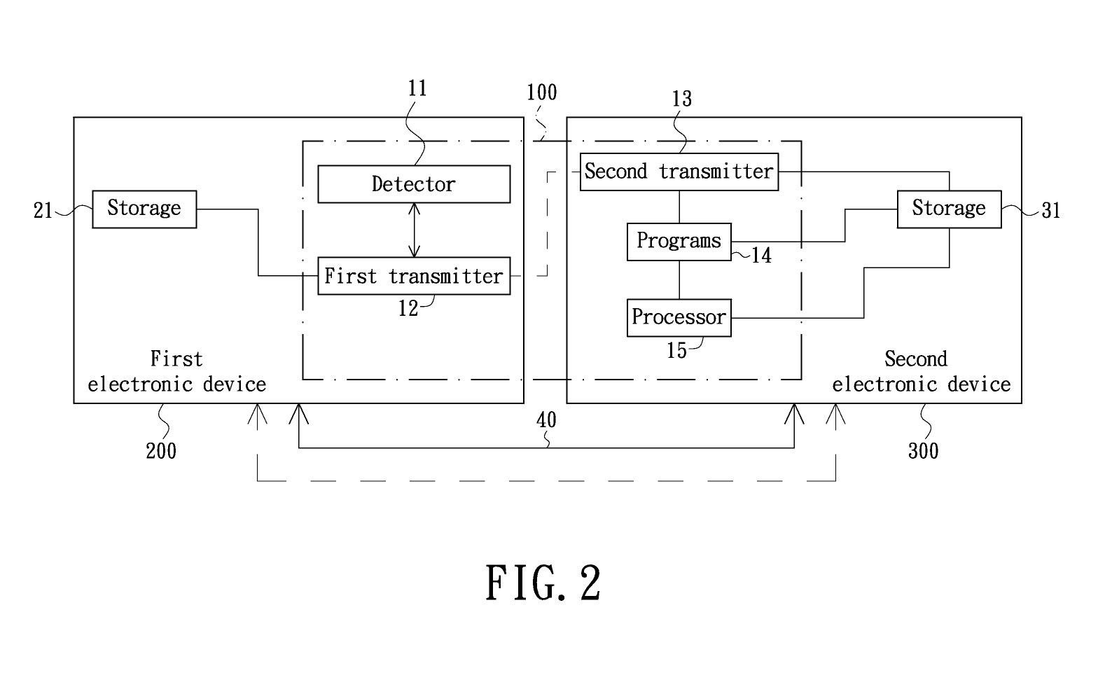

Referring to FIGS. 1 and 2, FIG. 1 is a block view of the file managing mechanism in accordance with an embodiment of the present invention; FIG. 2 is a block view of the file managing mechanism shown in FIG. 1 in used state. A file management mechanism 100 for processing files from a first electronic device 200 on a second electronic device 300 is provided. In the embodiment, the first electronic device 200 is a smart phone, and the second electronic device 300 is a personal computer. The first electronic device 200 and the second electronic device 300 can be connected wirelessly or connected with cable 40, so that the first electronic device 200 and the second electronic device 300 can communicate with each other. The first electronic device 200 includes storage 21 for storing data and files. The second electronic device 300 includes storage 31 for storing data and files.

The file management mechanism 100 includes a detector 11, a first transmitter 12, a second transmitter 13, programs 14 and a processor 15. The detector 11 and the first transmitter 12 are disposed in the first electronic device 200. The second transmitter 13 and the processor 15 are disposed in the second electronic device 300 while the programs 14 are installed therein. The detector 11 is provided for detecting that if the first electronic device 200 is connected to the second electronic device 300. While the first electronic device 200 being connected to the second electronic device 300, the first transmitter 12 uploads a file such as email attachments to be processed from the storage 21 of the first electronic device 21 to the second electronic device 300, inputs and sends a command for processing the file on the first electronic device 200 to the second electronic device 300, and the command is transmitted to the second transmitter 13 such that the command can be performed on the uploaded file by the second electronic device 300.

The second transmitter 13 downloads an index and locates the file to be processed in the second electronic device 300 according to the index. It should be noted that, the second transmitter 13 is mainly used to receive the file(s) from the first electronic device 200, and the index might be generated by or originally stored in the second electronic device 300 and be downloaded from storage means, such as storage 13, to allocate spaces in storage 21 (might be hard drive, memory or other storage means) for storing the uploaded file(s). It is well known by those skilled in the art that the operation of locating the files can also be done by the processor 15 in the second electronic device 300, such that the second transmitter 13 simply receives file(s) and, if necessary, index from the first electronic device 200 but not has to locate the file.

The programs 14 include many different programs respectively corresponding to different file types. One of the programs 14 corresponding to the file type or extension is activated to open and edit the file while directly receiving the file from the second transmitter 13 or obtained the file from the storage 21. The processor 15 creates a sync folder into the storage 31 of the second electronic device 31 wherein the file will be copied, when editing the file in the second electronic device 300, the processor 15 updates and indexes the sync folder on continuous bases, and storing the edited file into the storage 21 of the first electronic device 200.

The processor 15 can also be provided for prompting user to save changes while the file being edited while the file being edited. In another embodiment, the processor 15 is further provided for automatically saving an image copy of the file to both storage 31 of the second electronic device 300 and storage 21 of the first electronic device 200.

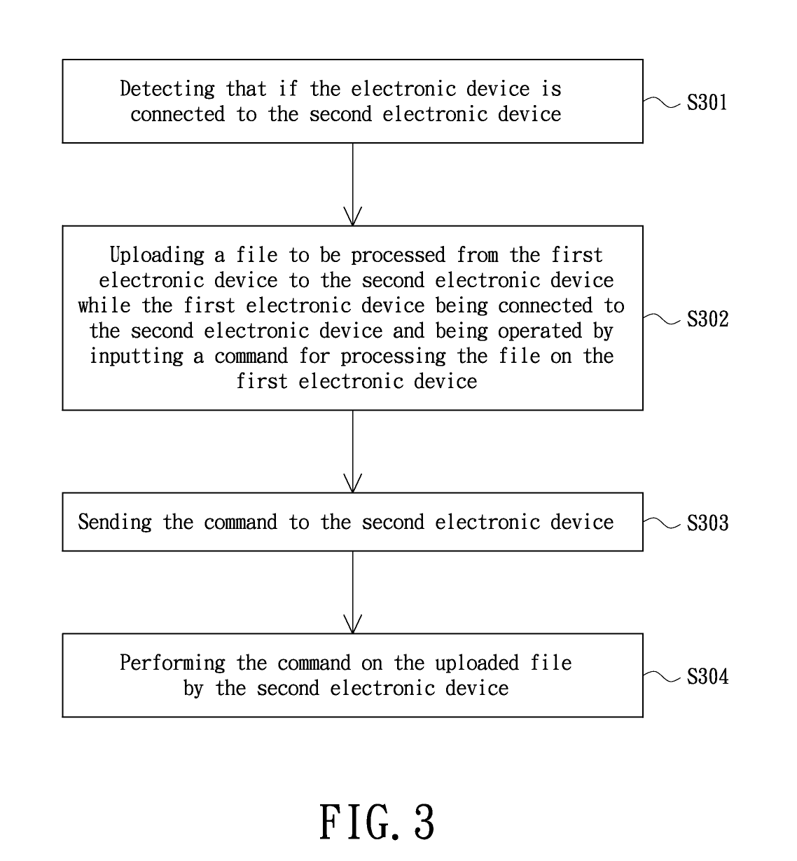

Referring to FIG. 3, a file managing method for processing files from the first electronic device 200 on the second electronic device 300 is also provided. The file managing method includes the following steps. Detecting that if the first electronic device 200 is connected to the second electronic device 30 (S301); uploading a file to be processed from the first electronic device 200 to the second electronic device 300 while the first electronic device 200 being connected to the second electronic device 300 and being operated by inputting a command for processing the file on the first electronic device 200 (S302); the first transmitter 12 sending the command to the second transmitter 13 of the second electronic device 300 (S303); and performing the command on the uploaded file by the processor 15 of the second electronic device 300 (S304).

Generally, there are many ways to upload a file from the first electronic device 200 to the second electronic device 300 when performing step S302. One way to upload the file is directly transmitting the file to the second electronic device 300 and stores the second electronic device therein. Another way to upload the file(s) is transmitting the file(s) and classifies the uploaded file(s) according to an index having many categories to store the file(s) in the second electronic device 300, such that the uploaded file(s) can be accessed easier by introducing the index. Or, still in another way, the file(s) is classified according to an index having many categories before uploading, and the index and file(s) are uploaded to the second electronic device 300 together such that the uploaded file(s) can be accessed through indexing by the index.

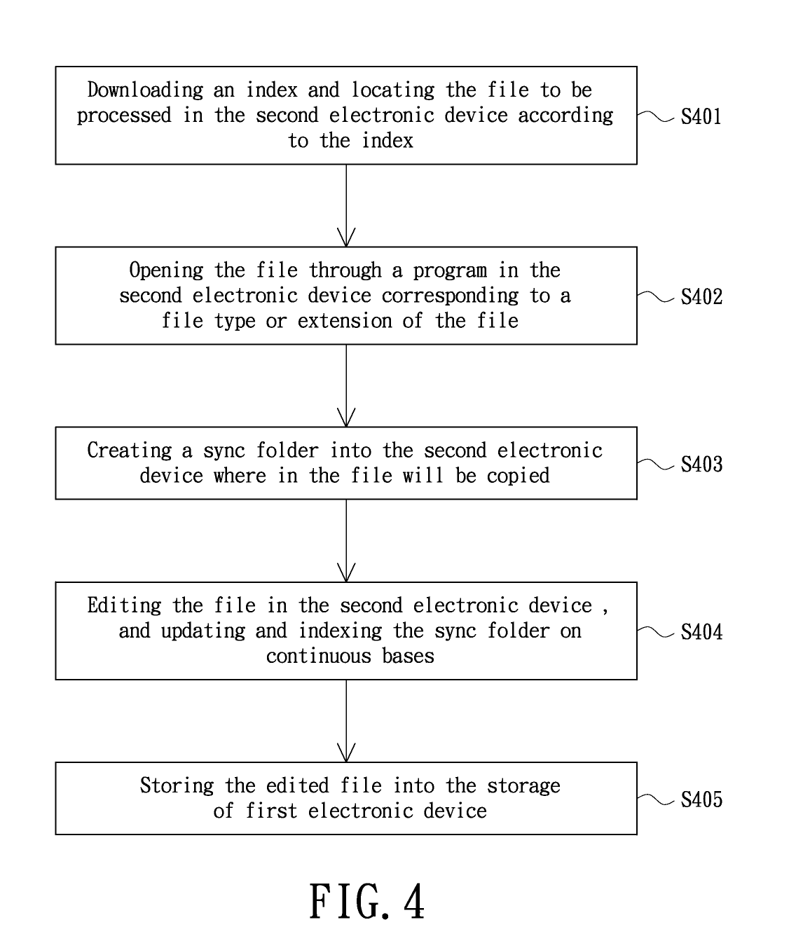

Referring to FIG. 4, FIG. 4 is a flow chart of step S304 in accordance with an embodiment of the present invention. In the step S304, the processor 15 downloads the index (either from the first electronic device or second electronic device) stated above and locates the file to be processed in the second electronic device 300 according to the index (S401); the processor 15 opens the file by performing the program 14 corresponding to file type or extension of the file (S402), creates a sync folder into the storage 31 of the second electronic device 300 wherein the file will be copied (S403), edits the file in the second electronic device 300, and updates and indexes the sync folder on continuous bases (S404); and the edited file is stored back into the storage 21 of first electronic device 200 (S405).

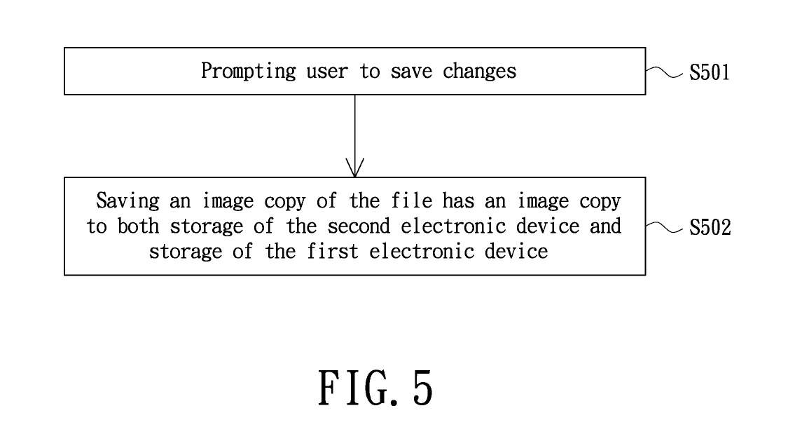

Referring to FIG. 5, FIG. 5 is a flow chart of the step S405 in accordance with an embodiment of the present invention. In this embodiment, the processor 15 prompts the user to save changes (S501); and saving an image copy of the file has an image copy to both storage 31 of the second electronic device 300 and storage 21 of the first electronic device 200 (S502).

In another embodiment, in the step S405, the processor 15 automatically saves an image copy of the file to both storage 31 of the second electronic device 300 and storage 21 of the first electronic device 200.

As stated above, the present invention is implemented for file access from the first electronic device to the second electronic device with more user friendly peripherals while keeping the file reference location at the first electronic device. And upon connecting the first electronic device to the second electronic device, service running on both sides will manage the file opening and management in a way which will take advantage of the more user friendly environment of processing files using the second electronic device.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A file managing method, the method provided for processing files from a first electronic device on a second electronic device, the file managing method comprising steps of:
detecting whether the first electronic device is connected to the second electronic device;
uploading a file to be processed from the first electronic device to the second electronic device while the first electronic device being connected to the second electronic device and being operated by inputting a command for processing the file on the first electronic device;
sending the command to the second electronic device; and
performing the command on the uploaded file by the second electronic device.

2. The file managing method as claimed in claim 1, wherein the file includes email attachments.

3. The file managing method as claimed in claim 1, wherein the step of uploading the file to be processed from the first electronic device to the second electronic device comprising:
downloading an index and locating the file to be processed in the second electronic device according to the index.

4. The file managing method as claimed in claim 3, wherein the step of performing the command on the uploaded file by the second electronic device comprising:
opening the file through a program in the second electronic device corresponding to a file type or extension of the file;
creating a sync folder into the second electronic device wherein the file will be copied;
editing the file in the second electronic device, and updating and indexing the sync folder on continuous bases; and
storing the edited file into the storage of first electronic device.

5. The file managing method as claimed in claim 4, wherein the step of editing the file in the second electronic device, and updating and indexing the sync folder on continuous bases comprises steps of:
prompting user to save changes; and
saving an image copy of the file has an image copy to both storage of the second electronic device and storage of the first electronic device.

6. The file managing method as claimed in claim 4, wherein the step of editing the file in the second electronic device, and updating and indexing the sync folder on continuous bases comprises step of:
automatically saving an image copy of the file to both storage of the second electronic device and storage of the first electronic device.

7. A file management mechanism provided for processing files from a first electronic device on a second electronic device, the file management mechanism comprising:
a detector disposed in the first electronic device for detecting that if the first electronic device is connected to the second electronic device; and
a first transmitter disposed in the first electronic device for uploading a file to be processed from the first electronic device to the second electronic device while the first electronic device being connected to the second electronic device, and for sending a command inputted on the first electronic device for processing the file on the first electronic device to the second electronic device such that the command is performed on the uploaded file by the second electronic device.

8. The file management mechanism as claimed in claim 7, further comprising:
a second transmitter disposed in the second electronic device for receiving the files uploaded from the first transmitter; and
a processor disposed in the second electronic device for performing a program corresponding to the file type or extension to open or edit the file, creating a sync folder into the second electronic device wherein the file will be copied, when editing the file in the second electronic device, the processor updating and indexing the sync folder on continuous bases, and storing the edited file into the storage of first electronic device.

9. The file management mechanism as claimed in claim 8, wherein the file includes email attachments.

10. The file management mechanism as claimed in claim 8, wherein the processor is further provided for prompting user to save changes.

11. The file management mechanism as claimed in claim 8, wherein the processor is further provided for automatically saving an image copy of the file to both storage of the second electronic device and storage of the first electronic device.

12. The file management mechanism as claimed in claim 8, wherein the second transmitter further downloading an index and locating the file to be processed in the second electronic device according to the index.
